(19) United States
(12) Patent Application Publication
(10) Pub. No.: US 2005/0216120 A1
(43) Pub. Date: Sep. 29, 2005

(54) Automatic vending machine and method

(76) Inventors: Yair Rosenberg, Ramat HaSharon (IL); Ofer Reklis, Kfar Saba (IL)

Correspondence Address: NATH & ASSOCIATES, PLLC;Sixth Floor, 1030 15th Street, N.W., Washington, DC, 20005, US

(21) Appl. No.: 11/091,717

(22) Filed: Mar. 29, 2005

Related U.S. Application Data
(60) Provisional application No. 60/556,876, filed on Mar. 29, 2004.

(30) Foreign Application Priority Data
May 24, 2004 (GB) 0411531.7

(51) Int. Cl. G07F 11/00; G06F 17/00

(52) U.S. Cl. 700/244; 700/235; 700/242; 700/237

(57) ABSTRACT

An automatic vending machine and method are presented. The machine comprises a cells' arrangement having an arrays of cells, each for storing an article therein; a monitoring system comprising an article identifier assembly configured and operable for identifying an article-related data in each of the cells; an article delivering assembly comprising an article holder for receiving a predefined article removed from the respective cell and allowing delivery of the removed article to a customer; and a control system connectable to the article identifier assembly and to the article delivery assembly for selectively operating these assemblies and recording data indicative of articles currently stored in the cells' arrangement and of article removed from the cells' arrangement.

### FIELD OF THE INVENTION

This invention relates to an automatic machine and method for vending and/or renting objects.

### BACKGROUND OF THE INVENTION

Automatic vending machines are widely used in public places and offer a variety of merchandise such as hot and cold drinks, food, video cassettes/disks, etc. The most commonly used type of a vending machine is that utilizing a rotating carousel (storage means)

U.S. Pat. No. 4,942,954 discloses a vending machine having a carousel containing several rotatable trays stacked one above another. The trays carry and present for vending selected items, such as food and merchandise. The carousel is contained in a housing or canister and is part of an integrated assembly with a coin container. The carousel is filled at a central depot rather than at the site where the machine is installed for use by customers. The customer locations have the cabinet of the machine. Fixed in the cabinet is a drive mechanism for the carousel and locating and guide members which enable integrated assemblies to be removed from the cabinet and fresh assemblies, with the carousel trays loaded at the central depot, to be installed in place of the removed assemblies. The coin box when empty is equipped with a mechanism which is set to enable coins to drop into the container and is automatically reset so as to close the opening when the assembly is removed from the cabinet. The important advantage of not requiring vending machine servicing personnel for being responsible for stocking or handling of moneys is obtained with this vending machine. However, this technique suffers from several drawbacks: The selling process is inefficient, since no recharge takes place during the ‘living cycle’ of a carousel (from in time thus resulting in reduced purchasing rate. In addition, an operator is needed to continuously check the status of a carousel in order to decide as to whether to replace it.

U.S. Pat. No. 5,020,958 discloses an article handling method and system for an article handing machine operable by users having identification (ID) cards bearing user identifying codes for vending and/or receiving articles, which bear the article identifying codes and are stored within storage bins in the machine. The article handling system includes an article transport and a user and article code reading arrangement. The article transport is selectively operable in a vending mode to transport user-selected articles from their storage bins to a position accessible to machine users for removal of the selected articles from the later return of the articles to the machine and in a return mode to transport returned articles from the user accessible position to their storage bins. The user and article code reading arrangement embodies a single common code reader for reading both the user code on user ID cards inserted into the machine and the article codes on articles vended to and returned by machine users. The disclosed article handling machine is a vending machine which vends user-selected magnetic tape cassettes, such as video cassettes, in response to insertion of a proper user ID card and rental fee into the machine and embodies a novel telephone cassette reservation feature, cassette/storage bin association feature, and rental fee credit feature for prompt cassette return.

U.S. Patent Application No. 2003/0034353 discloses automated parts dispensing system and method including a dispensing device in communication with a parts vending system. The dispensing device is one of the commonly known machines for dispensing parts, tools, foods, novelty items and other such items which generally use a helical coil or robotic delivery system. The particular device disclosed is a carrousel or drum type device. The dispensing device is modified to detect the rotation and position of the drum element and to detect the delivery of parts. The parts vending system controls and monitors the dispensing device or devices to assure proper operation and authorization of users. The user is aided in the requesting for parts by the correlating of vehicle identification number and identified operations or part type. This relieves the user of the task of identifying a particular configuration of part where vehicle models may have variations by vehicle identification numbers, etc. The parts vending system may also be in communication with a dealer management system to account for inventory, billing, status and other management functions, as well as, a bulk fluid management system.

U.S. Patent Application No. 2003/0062378 describes a dispensing mechanism for a vending machine for permitting generally flat faced product to be vended one at a time, said mechanism comprising an upright storage chute in which identical shaped and sized product can be stacked one on top of the other so the flat face of said generally flat faced product lies generally transversely of vertical, said storage chute being defined by a first generally upright extending wall and a spaced and opposed second generally upright extended wall, the spacing being sufficient to allow the product to move in a generally vertical path in said chute by gravity from the top to the bottom of the chute, there being an inclined product discharge ramp extending downwardly across said chute towards a product discharge opening in said second wall, there being a first tongue and a vertically lower spaced second tongue mounted to advance and retreat into said path through said second wall at the bottom of the stack, a lowermost product being supported in said chute by a support surface in said path opposite where said first tongue extends through said second wall and by said first tongue when said first tongue is advanced into said path through said second wall, the weight of all products being carried by said support surface and said first tongue, there being movement means to permit said second tongue to retreat when said first tongue is advanced, and to permit said second tongue to be advanced when said first tongue is retreated, so said second tongue will catch a lowermost edge of the lowermost product as it falls past said first tongue when said first tongue is retreated and so said lowermost product will then be supported in said chute by said support surface and by said second tongue, the vertical spacing of said first tongue and said second tongue being such that when the lowermost product is caught by the second tongue, the next highermost product in the stack will be positioned so that the first tongue can be advanced under that product so that that product and all products thereabove will be carried by said upper part of said inclined ramp and said first tongue, and so as said second tongue is retreated the product caught on said second tongue will fall by gravity onto said inclined ramp and pass through said discharge opening and be vended.

### SUMMARY OF THE INVENTION

There is a need in the art to improve vending of items by providing a novel vending machine which can automatically control and monitor its stocks and deliveries.

The main idea of the present invention is associated with the following. Commonly used vending machines do not provide for automatically monitoring of its compartments (cabinet cells) and for identifying which product is stored in the compartment. As a result the conventional vending machine is designed such that each compartment is intended for storage of a specific item. Moreover, it is desirable to enable remote monitoring of a vending machine, from a central station via a communication network.

The present invention solves the above problems by providing a novel vending machine configured and operable for independently and automatically identifying each of its cabinet cells, as well as any article stored in it or delivered to it, and enabling monitoring the machine operation via a communication network.

Thus, according to one broad aspect of the present invention, there is provided an automatic vending machine comprising:
(a) a cells' arrangement having an arrays of cells, each for storing at least one article therein,
(b) an article delivering assembly comprising an article holder for receiving at least one predefined article removed from the respective at least one cell and allowing delivery of the at least one removed article to a customer;
(c) a monitoring system comprising an article identifier assembly configured and operable for determining an article-related data in any of the cells thereby enabling arbitrary positioning of the articles within the cells' arrangement; and
(d) a control system connectable to the monitoring system and to the article delivery assembly for selectively operating them and recording data indicative of articles currently stored in the cells' arrangement and of articles removed from the cells' arrangement.

The monitoring system preferably comprises a mapping assembly for mapping the cells' arrangement. The mapping assembly includes determination of a pattern of the cells. The pattern is indicative of the cells' dimensions and their spatial distribution within the cells arrangement. The mapping assembly may be configured and operable to determine borders of the cells in the cells' arrangement.

The article-related data may include an identification code provided on the article, thereby enabling identifying the article type according to data stored in the control system. Alternatively or additionally, the article-related data includes data indicative of an image of the article. The mapping assembly may be configured and operable for imaging each of the cells, thus enabling to identify a type of the article located in the cell.

The machine comprises a drive assembly operable by the control system to provide a relative displacement between the article identifier assembly and the cells' arrangement, thereby enabling any appropriate positioning of the article identifier assembly relative to the cells' arrangement. The drive assembly may be associated with the article identifier assembly for moving it with respect to the cells' arrangement, and/or with the cells' arrangement for moving it with respect to the article identifier assembly. The relative displacement may include a relative rotation, and/or a back and forward movement of the article identifier assembly with respect to the cells arrangement along at least one axis.

The array of cells may one-, two-, or three-dimensional array. The cells' arrangement may be configured as a frame with a polygonal outer surface, or a substantially circular outer surface or apiary like outer surface. The cells arrangement may be configured to allow for adjusting dimensions of at least some of the cells.

The article identifier assembly includes a data reading unit configured for collecting radiation originating from a selected region and generating data indicative thereof. The data reading unit may include a camera for acquiring an image of the selected region; a radiation source for irradiating the selected region and a detector for collecting a radiation response of said region. The data reading unit may be configured for reading at least one of the following: an optical barcode, a magnetic tag, and an RF tag. (such as Wi-Fi tag, WUB tag, or any other protocol capable of recognizing the product identification code).

The article-related data may be indicative of presence or absence of any article in the cell. In this case, each of the cells is preferably provided on its inner surface with a marker detectable when no article is present in the cell. The marker may be configured for reflecting predetermined radiation, in which case the article identifier assembly includes a radiation source operable to generate this predetermined radiation.

The article identifier assembly preferably includes a lift unit carrying the data reading unit and mounted on a guide assembly for back and forward movement along at least one axis defined by the guide assembly.

The article delivery assembly comprises an article removing assembly. The latter may be mounted on the holder and configured for capturing the article in the cell and transferring it to said holder (for example by gripping the article), or may be configured for pushing the article from the cell towards the holder. The article removing assembly may comprises an actuator located at a rear side of the cell and operable to push the article in this cell towards a holder located at a front side of the cell or at the bottom of the cells' arrangement accessible by a customer (e.g., just pushing the article to drop it down where it is received by a holder).

The article removing assembly preferably includes a lift unit mounted on a guide assembly and driven for a back and forward movement along at least one axis defined by the guide assembly with respect to the cells arrangement. The actuator may include an array of pushing members, each associated with a corresponding one of the cells. The actuator may include a single pushing member, in which case the machine includes a drive mechanism configured to provide a relative displacement between the pushing member and the cells arrangement. The pushing member is preferably driven for a back and forward movement with respect to the cells arrangement along at least one axis. This may be implemented by supporting the pushing member on a second lift unit mounted on a guide assembly for the movement along the at least one axis defined by the guide assembly. The machine may utilize one actuator and one data reading unit for each tray.

The article delivery assembly preferably comprises a data reading unit configured for collecting radiation originating from a selected region and generating data indicative thereof, to thereby enable identifying the removed article prior to being delivered to a customer. This data reading unit may be part of the article identifier assembly. The data reading unit is preferably supported on a lift unit mounted on a guide assembly for a back and forward movement along at least one axis defined by the guide assembly with respect to the cells arrangement.

The control system is preferably connectable to a network. The control system may have a local controller connected to and operating the article identifier assembly and the article delivery assembly, wherein the local controller is connectable to a central controller via a network to be managed by the central controller.

Preferably, the machine also includes a recycling or return assembly configured for receiving an article from outside the machine. The recycling or return assembly comprises an article identifier assembly for identifying the article being input from the outside the machine and generating data indicative thereof to the control system, to thereby enabling processing of this data and determining whether the article being input is allowed to be collected or not. The article identifier assembly includes a data reading unit, which may be an imaging unit capable of generating the data indicative of the image of the article being input, and/or may be configured for determining article-related enabling identification of the article. This may be implemented by reading an identification code provided on the article (for example, optical barcode or RFID) and/or determining any other parameter(s) of the article, such as weight, size, shape, material colors, or any other parameter allowing for the article authentication.

The recycling (or return) assembly may be implemented by using a loading/unloading member configured for holding an article being input to allow its identification, and then, depending on the identification results, displacing the article towards a collection channel or towards a return channel. The article holding member is configured and operable by the control system so as to be shiftable between different positions with respect to the inside of the machine, such that in its one position the member supports the article in a manner to allow its identification by a data reading assembly, and in its other positions the member allows loading of the article being input so as to be collected in the machine, and unloading of the article to be pushed towards the outside of the machine to a customer or collected in a recycle chamber, as the case may be.

According to another broad aspect of the invention, there is provided an automatic vending machine comprising:
(a) a cells' arrangement having an arrays of cells, each for storing at least one article therein,
(b) an article delivering assembly comprising an article holder for receiving a predefined article removed from the respective cell and allowing delivery of the removed article to a customer;
(c) a monitoring system configured for determining an article-related data in any of the cells thereby enabling arbitrary positioning of the articles within the cells' arrangement, and for mapping the cells' arrangement, thereby enabling reconfiguring of the cells' arrangement when desired; and
(d) a control system connectable to the monitoring system and to the article delivery assembly for selectively operating these assemblies and recording data indicative of articles currently stored in the cells' arrangement and of article removed from the cells' arrangement.

According to yet another broad aspect of the invention, there is provided an automatic vending machine comprising:
(a) a cells' arrangement having an arrays of cells, each for storing at least one article therein,
(b) an article delivering assembly comprising an article holder for receiving a predefined article removed from the respective cell and allowing delivery of the removed article to a customer;
(c) a monitoring system configured and operable for determining an article-related data in any of the cells thereby enabling arbitrary positioning of the articles within the cells' arrangement;
(d) an article recycling or returning assembly configured and operable for receiving an article from outside the machine and generating data indicative of the received article;
(e) a control system connectable to the monitoring system, to the article delivery assembly, and to the article recycling or returning assembly, for selectively operating them, recording data indicative of articles currently stored in the cells' arrangement and of article removed from the cells' arrangement, and processing the data indicative of the received article to allow its return to the machine.

According to yet another broad aspect of the invention, there is provided a control system for operating a machine for vending articles, the control system comprising:
a memory utility operable for storing data indicative of the cells' arrangement, articles currently stored in the cells' arrangement, and article removed from the cells' arrangement;
a data processing and analyzing utility configured for selectively carrying out the following: managing the memory utility by processing data coming from the monitoring system and indicative of at least one of the articles identified in the machine and/or of the cells' arrangement, and generating data to be stored in the memory and/or to update the previously stored data; managing delivery of the selected article by being responsive to a customer's request and using the stored data to operate an article delivery assembly of the machine and record data indicative of the delivered article.

According to yet another broad aspect of the present invention, there is provided a method for operating a machine for vending articles, the method comprising:
automatically identifying article-related data with respect to articles currently stored in a cells' arrangement of the machine while being arbitrary distributed in said cells' arrangement and recording data indicative of specific identity or types of the articles and their positions in the machine;
in response to a customer's request, operating delivery of the selected article from the machine to the customer and recording data indicative of delivered articles.

According to yet another broad aspect of the present invention, there is provided a method for managing operation of a plurality of vending machines relating to a common chain, said managing comprising: providing each of the vending machines with a local controller and connecting all the local controllers to a central controller via a network.

The management may include management of the “kiosk” function of the vending machine. This may be implemented by connecting the vending machine to one or many kiosk arrangements and controlling the kiosk arrangement(s)' operation by the local controller of said vending machine that communicates with a central chain controller via a network.

According to yet another aspect of the invention, there is provided a monitoring system for use in a vending machine, the system comprising:
an article identifier assembly configured and operable for identifying article-related data with respect of each of the articles to be vended by the vending machine;
a drive assembly configured and operated to provide a relative displacement between the article identifier assembly and a cells' arrangement of the vending machine where the articles are stored in the cells, respectively;
a control system operating said drive assembly and the article identifier assembly to successively align the article identifier assembly with each of the cells and determine the article-related data for each of the cells.

According to yet another aspect of the invention, there is provided a method for purchasing articles in the cyberspace to be delivered by automatic vending machine, the method comprising:
providing a Website operated by a central control system via a network to offer articles for vending;
in response to a customer's selection of an article to be vended in a specific vending machine, said central control system operating to instruct said vending machine to keep said article for the customer, thereby enabling the customer to arrive at the location of said vending machine and receive said article.

According to yet another aspect of the invention, there is provided a method for providing services by automatic vending machine, the method comprising: providing at least one automatic vending machine controlled by a central control system; and operating, by said central control system, services to be provided to a customer via said automatic vending machine.

According to yet another broad aspect of the invention, there is provided a method for managing purchase of articles via vending machines, the method comprising:
(a) allowing a customer to purchase an article using the cyberspace;
(b) allowing said customer to receive the purchased article form a predetermined vending machine.

The purchasing via the cyberspace includes identifying the article location in a certain vending machine from a chain of such machines managed by a control station.

According to the technique of the present invention, a customer is preferably also provided with complementary services to a customer beside vending and recycling (or return), in the same place. These services include additional information, or a so-called “information kiosk”. The latter may include provision of more information about the purchased article (generally articles vended by the machine) or about other articles either related or not related to the purchased article (existing articles in the machine). The information kiosk may include means to continue the transactions with machine at a different location or means to perform different transaction in a different place which is connected to machine by any business relation (e.g., bill payment via the Internet). Also, according to the invention, the vending machine is operated to provide customers with purchasing means to be used for purchasing article(s) other than those existing in the vending machine.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 is a schematic illustration of a vending machine according to the invention from the customer's point of view;

FIG. 2A schematically illustrates the construction of the vending machine of the present invention;

FIG. 2B exemplifies the configuration of an article removing assembly that can be used in the system of the present invention;

FIG. 3 exemplifies a cells' arrangement suitable to be used in the vending machine of the present invention;

FIGS. 4A-4B exemplify how the cells of the cells arrangement can be resized;

FIG. 4C illustrates another example of the cells' arrangement configuration allowing rearrangement of cells;

FIGS. 5A and 5B schematically illustrate two examples, respectively, of an article recycling assembly suitable to be used in the vending machine of the present invention;

FIG. 5C illustrates another example of the article recycling assembly configuration suitable to be used in the vending machine of the present invention;

FIG. 5D illustrates yet another example of the article recycling assembly configuration suitable to be used in the vending machine of the present invention;

FIG. 6 exemplifies a centralized vending machines' system of the present invention;

FIG. 7 is a flow diagram of an example of a method according to the invention for calibrating a vending machine to be ready for vending articles;

FIG. 8 is an example of a method of the invention for loading the vending machine with articles; and

FIG. 9 shows an example of a method of the invention for operating a vending process.

### DETAILED DESCRIPTION OF THE INVENTION

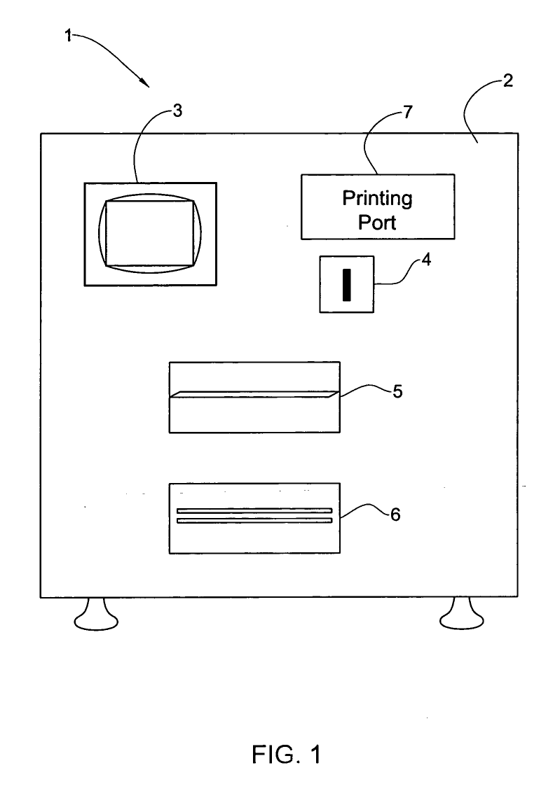

Referring to FIG. 1 there is schematically illustrated a vending machine 1 configured and operable according to the invention. The machine 1 includes a housing 2 containing a cells' arrangement where articles are located, a monitoring system, an article delivery system (which assemblies are not shown here), and a control system including inter alia a data presentation unit (display) 3 for presenting any relevant information to a customer. The display may be of any known design, for example equipped with a touch screen function, etc. The displayed information is any information relevant to a customer in order to be served by machine 1. This may include articles-related data, namely, a list of articles available in the machine, description of such articles, images of the articles available in the machine, prices, etc. The user interface unit may typically provide a customer with several options regarding receiving the article, paying for the article, and possible also recycling articles or parts thereof.

A customer, having decided what he is interested in, selects and touches the appropriate point on the screen 3, and the selected action is conducted by machine 1. Generally, the user interface unit is configured to allow a customer to operate and communicate with machine 1 or its centralized management to which a local controller (not shown) of the machine is connected via a network, as will be described further below. The machine 1 may include a voice system (VOIP system), and/or a phone system by which such communication can be made, for example to enable the customer to communicate with the centralized management in order to get some assistance.

Further typically provided in the machine is a payment-managing arrangement 4 that includes a slot configured for inserting either the customer related card, which may be a typical credit card, or any other magnetic card, smart card, or RF card (e.g., a specific card provided for customers frequently using the machine services), and/or cash, and/or coins, etc. The same arrangement 4 or an additional similar arrangement may be used for inserting an identification card of a machine operator for the machine maintenance purposes.

Articles are delivered through a dispensing port 5 associated with an article delivery assembly. Such port is an opening or a door through which articles are delivered from the machine 1. Preferably, the dispensing port 5 is an adjustable opening which can be enlarged or reduced according to the operator' s requirements for allowing delivery of one or many articles from the machine.

Preferably, the machine also includes an article recycling or return assembly 6, as will be described below. Considering for example such articles as printing inks (inkjet, ribbons, tuners), the empty ink case, after being used, may be recycled. The recycled case may and may not be that of the previously purchased ink from the same machine.

According to the invention, a vending machine is configured for automatically selling and delivering articles stored in the machine. The machine could also collect articles delivered by customers (not shown in the figure). Thus, the automatic vending machine of the present invention is capable of independently managing its articles (storage, supply, quantities, prices, etc.). It should be noted, although not specifically shown, that depending on the type of articles stored in the vended machine, the machine may include additional appropriate means, such as refrigerating and/or heating means for food, drinks or drugs, air drier for hygroscopic articles, etc.

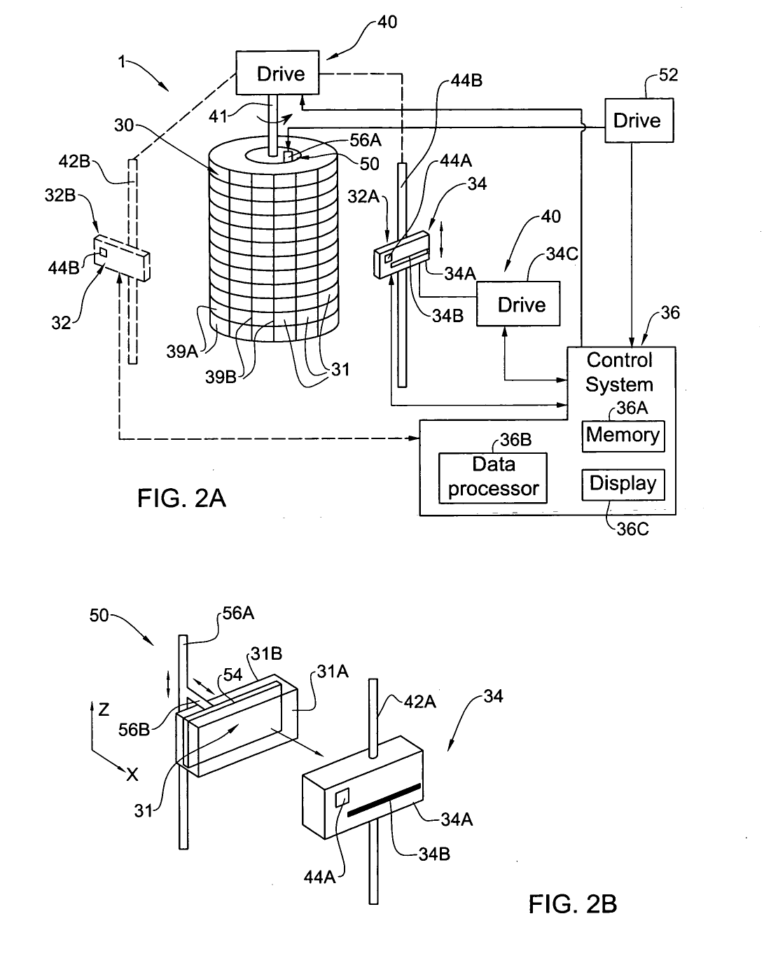

Reference is now made to FIG. 2A schematically illustrating the construction and operation of the automatic vending machine 1 according to the invention. Machine 1 includes a cells arrangement 30 for storing articles that are to be distributed and/or collected; a monitoring system 32; an article delivering assembly 34 which delivers articles from the machine to a customer; and a control system 36.

Cells' arrangement 30 is an array of cells 31, each for storing one or more article therein. The cells' arrangement 30 is any appropriate storage means. According to an example of the invention, the cells' arrangement is configured as adjustable storage. The cells' arrangement can be configured as a carousel-like, a box-like volume, an apiary-like arrangement, etc. The carousel-like configuration is preferred for the purposes of reducing the footprint of the system. The cells' arrangement 30 is formed by a plurality of cells 31 that may and may not be of the same size. In the present example, the cells' arrangement 30 is designed as a closed tubular-like frame (with a substantially circular outer surface), but is should be understood that the outer surface of the closed frame may be a polygon, and an open frame may be used as well. The cells 31 are arranged in an array, which is a three-dimensional array in the present example, but is should be understood that the frame may be designed to form a one- or two-dimensional array arrangement of cells. Thus, in the present example, the cells 31 are arranged in several circular arrays, one above the other. Generally, the cells 31 are arranged in multiple-cell shelves 39A with dividers 39B between each two adjacent cells 31. The cells' arrangement 30 may be configured to allow for appropriately adjusting the cells' dimensions. To this end, the shelves 39A as well as dividers 39B are removably mounted, as will be described below.

Monitoring system 32 includes an article identifier assembly 32A and preferably also includes a cells' mapping assembly 32B as shown in the figure in dashed lines. It should be noted that the article identifying and mapping assemblies may be constituted by a common data reading system (e.g., imaging system), instead of two separate blocks as shown in the present example. All these assemblies are operated by the control system 36.

The control system 36 is typically a computer system including a memory utility 36A, a data processing and analyzing utility 36B and a data presentation unit 36C (3 in FIG. 1). The control system may be a local computer system connected to the machine, or a remote computer system connected to the machine via a network, or preferably the so-called “distributed” control system formed by a local computer and a central computer connectable to each other via a network.

The article identifier assembly 32A is configured and operable for determining an article-related data in any of the cells thereby enabling arbitrary positioning of the articles within in any of the cells arrangement. It should be noted that in this respect, article-related data comprises also a determination that no article is present in certain cell(s) 31. As indicated above, the monitoring system 32 preferably also includes mapping assembly 32B for mapping the cells' arrangement. The mapping assembly 32B is configured for determining of at least one of the following: a pattern of the cells, cells' dimensions, cell's borders, including the shapes and volumes, and spatial distribution of the cells within the cells arrangement (relative locations), thus enabling recording the cells' arrangement map prior to loading or after unloading the machine with articles or reconfiguration of cell's arrangements 30.

The monitoring system 32 is accommodated adjacent to the cells' arrangement 30. it can be mounted outside cell's arrangement 30 as shown in FIG. 2A, or within its internal hollow part (the upper side of which is indicated by the tip of arrow 50). The machine has an appropriate drive mechanism operable to provide a relative displacement between the cells arrangement 30 and the monitoring system 32. In the present example, this is implemented by a relative rotation between the cells arrangement and the monitoring system and a relative back and forward movement of the relevant parts of the monitoring system with respect to the cells arrangement along at least one axis. The relative rotation may generally be implemented by rotating the monitoring system with respect to the frame 30 and/or rotating the relevant parts of the monitoring system with respect to the frame, or rotating the frame 30 with respect to the monitoring system 32. As shown in the figure, a drive assembly 40 may be associated with a central shaft 41 of the frame assembly 30, and/or with guiding assemblies 42A and 42B of the monitoring system.

The article delivering assembly 34 includes an article holder 34A configured for receiving a predefined article removed from the respective cell and allowing delivery of the removed article to a customer. This may be a container having a slot (opening) or a door 34B selectively actuated by a drive 34C (operated by the control system) for outputting the article therethrough. The control system 36 selectively operates these assemblies and records data indicative of the articles currently stored in the cells' arrangement and of the articles removed from the cells' arrangement.

In the present example, the article identifier assembly 32A and mapping assembly 32B are shown as using separate units 44A and 44B associated with corresponding guide assemblies 42A and 42B, respectively. It should however be noted that units 44A and 44B may be incorporated within a common assembly. Additionally, in the present example, the article identifier assembly 32A is incorporated within the article delivery assembly 34, but it should be understood that it may be a stand alone assembly. For example, assembly 32B may constitute the monitoring system including the article identifier assembly and possibly also the mapping assembly.

The article identifier assembly 32A is implemented by providing an appropriately designed data reading unit 44A supported on a lift unit 34A (which in the present example is the article holder of the article delivery assembly 34) and mounted on a guide assembly 42A for movement along at least one axis defined by the guide assembly (the vertical axis in the present example). The data reading unit 44A is configured for collecting radiation originating from a selected region and generating data indicative thereof. Such a data reading unit may include a camera for acquiring an image of the selected region, in which case the data reading unit may be used for both identifying the article and mapping the cells arrangement. The data reading unit may include a radiation source for irradiating the selected region and a detector for collecting a radiation response of the irradiated region, so as to read an identification code provided on the article. It should be noted that in this respect, the identification information may originate from the article itself or can be on a casing in which the article is encased, or on both (e.g., when transparent casing is used).

It should be understood that an identification code is an article-related data; The code is generated by any known technique consisting of assigning a specific data stream to an article which can then be automatically identified. Such an ID can be a barcode, an RF tag (data in the form of a sequence of response signals of RF circuits), a magnetic tag (a pattern formed by magnetic elements responsive to an external magnetic field), etc. Accordingly, the data reading unit 44A may be an optical system, and/or a magnetic field source, etc. It could also be the case that such optical or magnetic system is provided with appropriate means (e.g., a camera equipped with wide angle lenses) that enables the data reading unit 44A to detect simultaneously few cells, and therefore, the data reading unit 44A can be moved faster and more efficiently during, e.g., scanning the overall frame 30. Data reading unit 44A can also be mounted outside the cell' s arrangement 30 or within its inner space, adjacent to drive 40.

It should also be noted that the article-related data may be indicative of the presence or absence of any article in the cell. In this case, each of the cells may be provided on its inner surface with a marker detectable when no article is present in the cell. Such a marker may be configured for reflecting predetermined radiation or generating a radiation response to predetermined exciting radiation. The data reader thus includes a radiation source operable to generate this predetermined radiation and a radiation detector to read the returned (reflected, excited) radiation. Thus, generally, such a data reading unit emits “reading” electromagnetic radiation towards the cell currently aligned with the data reading unit to cause a radiation response of the respective identification code on the article in the cell or on the inner surface of the cell.

The monitoring system 32 (article identifier assembly 32A and possibly also the mapping assembly 32B) can, at any point in time, inspect (scan) the cell's arrangement 30, preferably, any point on or in cell's arrangement 30, and determine, inter alia, the empty cells and the exact articles which reside in each of the cells. It should be noted that more than one article in a cell is also a predetermined vending option if, e.g., a special sale is considered, where upon purchasing one article, another (identical) article is delivered (the so called “1+1 for free” sale). In such a sale, monitoring system 32 can determine if cells were loaded properly (e.g., two identical articles per cell) and manages the stocks. The relative displacement between the data reading unit provides for appropriately positioning the data reading unit with respect to any cell of the cells' arrangement 30. Such a positioning assembly can be of the kind effecting rotation and vertical movement of the data reading unit with respect to the stationary mounted cells arrangement 30. In the present example of FIG. 2A, the data reading unit 44A is mounted on the holder 34A, which is in turn mounted for vertical movement along the axis of the guide member 42A, thus vertically displacing the unit 44A with respect to the cells arrangement 30. Thus, the data reading (i.e., scanning of the cells) is implemented by rotating the cells' arrangement 30 with respect to the assembly 32A (or rotating the assembly 32A with respect to the cells arrangement 30) and vertically moving the data reading unit 44A (the holder 34A) with respect to the cells arrangement 30. It should be understood that any other contractual configuration is possible, provided it is designed for a relative displacement between the relevant part of the monitoring system 32 and the cells arrangement 30, in any predetermined spatial resolution (in x, y, z axes).

The mapping assembly 32B is designed and operated to enable obtaining data indicative of the cells' dimensions, forms or volumes and their relative position within the array of cells. To this end, another data reading unit 44B may be configured for detecting, during the relative displacement between the unit 44B and the cells arrangement 30, the borders (shelves and dividers) between the cells and shelves 39A. This may be achieved by using an imaging system (e.g., camera) in the data reading unit 44B, or by providing identification marks (e.g., reflectors of predetermined radiation, electromagnetic or acoustic radiation) on the cells and/or dividers and providing a source of such radiation in the data reading unit 44B. Thus, during the relative displacement between the data reading unit 44B and the cells' arrangement 30, data indicative of images of cell' s arrangement 30 or of a pattern of the cells' dividers is detected and/or created. This data is then processed with the aid of appropriate algorithms (e.g., pattern recognition algorithm) to determine the cells map and possibly also articles identification within the cells.

The mapping of the cells arrangement may be implemented by using a rotation counter (not shown) and a sensor (the data reading unit 44A or 44B). Such a rotation counter is a part of the rotation drive mechanism 40 and may be of the kind known in the art, capable of counting the number of relative rotations (e.g., rotation of the cells arrangement). The lift unit 42A or 42B, carrying the data reading unit, moves up and down along the guide axis. The vertical movement of the data reading unit combined with the rotation of the cells arrangement enable the control system 36 to appropriately position the data reading unit in order to identify either the shelf 39A or divider 39B. Mapping of the cells arrangement is performed automatically, i.e., the dimensions (width and height) of each cell are determined. The procedure begins with the data reading unit being brought to its initial position along the z-axis with respect to the cells arrangement, and is then moved along the z-axis (e.g., moves upward, when starting from the initial lowermost position). The shelves 39A are thus successively identified and the number of shelves is counted. Since the movement along the z-axis includes a distance meter, the control system 36 can calculate the vertical differences between any two successive shelves, and consequently, the height of any numbered cell. The width of any cell is determined starting from the initial lowermost position of the data reading unit and then rotating the cells arrangement 30 with respect to the data reading unit to successively identify the dividers 39B to thereby enable counting of the dividers. Consequently, with the measured rotated angle between any two successive dividers 39B, the width of any cell is determined. By such activities and numbering the cells, a complete cells map is established.

With such data obtained with any of the previous configurations, the control unit 36 (its data processing and analyzing utility) is response to data coming from the monitoring system, establishes the so-called “locations map”, which is a type of ‘look-up’ table that correlates an article with one or more locations in the cells' arrangement 30, and stores the map in the memory utility. Having provided the updated locations map, upon selection of an article by a customer, the control unit 36 can analyze the selected article related data and instruct the machine 1 (i.e., the article identifier assembly and the article delivery assembly) to locate this specific article and dispense it to the customer. However, if also cells' borders (or the entire image of cells arrangement loaded with articles) were identified, a more comprehensive ‘look-up’ table is established. Such a table is indicative not only of a specific location where the article identification code itself resides in space, but also of where exactly the article itself resides, thus facilitating the article delivery process. Based on predetermined cells' positions and dimensions, the data reading unit 44A is then directly targeted to locations where it is most likely to find the specific identification code. Thus, delivery and monitoring time of the vending machine 1 is significantly reduced.

The application of any of the aforesaid configurations of the article identifier assembly 32A and cells mapping assembly 32B, a partial or a complete map of articles with respect to cells can be established, i.e., for any chosen cell (position), the control unit 36 can adapt a stored article (or empty cell) and vice versa, for any one-to-one identified article or for any type of article, the control unit 36 can correlate any or all the cells in which such article is stored. As a result, a ‘look-up’ table is created in which to any article a position (cell) is correlated. These assemblies can be operated at any moment, e.g., before (un)loading, in order to establish or keep the ‘look-up’ table updated as vending process continues. Specifically, an operator can manually, at any given moment, load arbitrarily the machine 1 with articles of various types, wasting no time to correlate certain article to certain cell 31; once loading is completed, a ‘look up’ table can immediately be established, and the machine 1 is ready for use. Having such ‘look-up’ table established, powerful monitoring capabilities are established 30 as well. For example, the machine can be stopped from being operated at any chosen or predetermined moment (e.g., if the consumption of certain article reaches predetermined level). Reports concerning the re-loadings of a machine can be produced (e.g., in SMS or Email format). Moreover, an automatic and continuous connection is established from the central operation center to any remote vending machine. Based on such connection, any operational parameter can be monitored.

The article delivery assembly 34 is preferably equipped with a data reading unit. In the present example, this is data reading unit 44A of the monitoring system 32, but it should be understood that a separate data reading unit may be used in the article delivery assembly 34. The machine thus includes at least one data reading unit for identifying articles loaded in the cells arrangement. Preferably, the machine would include another data reading unit for identifying the selected article just prior to be delivered to a customer. The configuration of this second data reading unit is such that when the selected article becomes located on the holder 34A, the data reading unit 44A is operated to identify the article (e.g., by reading the identification code on the article and/or imaging the article, etc.). In a case a barcode is not identified, the conclusion maybe that a cell is empty or an article was placed in cell in such a position that its barcode could not be identified.

The invention further provides means and algorithm to tackle such situations. In this case, a camera (data reading unit 44A or 44B) of the monitoring system 32 images the article within the cell, and if required, the cell arrangement 30 itself. The image is then processed by the control unit 36 using an image processing algorithm. Such algorithm may have pre-determined thresholds and input parameters. Such algorithm can determine for example, based on comparative method, the presence or the absence of an article within a cell. According to such comparative method the algorithm compares spatial detected gray levels to a predetermined spatial gray levels ‘look-up’ table. Such ‘look-up’ table may be a two-dimensional map (matrix) of cells arrangement 30 loaded with images of articles according to the planned stock in such machine. It could also be images of an empty cell or any certain type of cells (if few dimensions are included in cell arrangement 30). The CPU then compares the spatial detected gray levels to the ‘look-up’ table, and if a matching, according to a predetermined gray level, is found, the result may be that an article is present, or moreover, it is a certain article. Alternatively, absolute methods could be applied to identify the presence of or identity an article: according to an exemplary method, a certain threshold is predetermined for empty cell 31 (where empty cells have uniform gray level appearance); if the calculated mean gray level of detected image is reached, the algorithm concludes that an empty cell 31 was identified. At last the control unit is updated according to the findings. The article-related data is processed to determine whether it matches that of the requested article and whether the article delivery is allowed by the payment managing assembly. Upon detecting that these conditions are satisfied, the control unit operates the article outputting element 34B to output the article from the holder unit 34A.

As indicated above, in order to reduce the machine footprint and save resources, few elements of the machine 1 can serve for various tasks in different assemblies, such as the same data reading unit 44A and the same positioning assembly (lift 34A and guide 42A) are used for establishing articles ‘look-up’ table and for articles delivery.

The machine provides for delivering a selected article out of its storage cell to a position where it can be collected by a customer, i.e., to the holder 34A having a spot or door 34B. To this end, the machine further includes an article removing assembly 50. The article removing assembly is generally configured so as to enable transfer of the selected article from the cell to the holder 34A of the article delivery assembly 34. This can be implemented by pushing or pulling means. The actuator may be mounted on the holder and configured for gripping (capturing) and transferring the article, or being a conveyor arm capable of supporting the article from its bottom side.

Preferably, the pushing element is used being associated with the cells arrangement. As shown in FIG. 2A, such a pushing-based article removing assembly 50 is accommodated in the cells arrangement being positioned inside the frame 30 so as to be at the rear side of the cell, and is driven by a drive assembly 52 operated by the control system 36.

As more specifically shown in FIG. 2B, the article removing assembly 50 is configured for pushing the article from the cell 31 towards the holder 34A of the article delivery assembly 34. It should, however, be noted that the article delivery assembly may be mounted for a movement along a certain horizontal plane located below the cells arrangement. In this case, the article removing assembly 50 just pushed the article from a specific cell to be dropped downward and received by the holder of the delivery assembly which is previously to a vertical alignment with this cell either by moving the cells' arrangement (rotation thereof in this specific example) or moving the delivery assembly along said plane. Generally, the system configuration is such as to allow alignment of the article removing assembly and the article delivery assembly with the respective cell. As exemplified in FIG. 2B, the holder 34A of the article delivery assembly is located at a front side 31A of the cell 31, and the article removing assembly 50 is accommodated at the rear side 31B of the cell 30.

The article removing assembly 50 comprises an actuator 54 supported on a guide assembly formed by a guiding element 56A extending along Z-axis and a guiding element 56B mounted on the guide 56A and extendable along X-axis away from the guide 56A. The actuator 54 is fixed to the distal end of the guide 56B to be therefore movable back and forward along the X-axis. It should be understood that, alternatively, such a movement of the actuator 54 (pushing member) towards and away from the cell 31 may be achieved by moving the guide 56A along the X-axis thus eliminating the need for the second guide 56B. The guide 56B (or the actuator 54 directly mounted on the guide 56A) is a lift unit driven for movement along the axis of the guide 56A. The guide 56A is in turn driven for rotation about the central axis of the cells arrangement 30 to thereby be brought to a selected cell from which the article is to be removed. It should be understood that, alternatively, an array of such pushing members (actuators) may be provided, each associated with a corresponding one of the cells thus eliminating a need for rotation and vertical movement; or each associated with a corresponding one of cells' columns thus eliminating a need for rotation of the actuator; or each associated with a corresponding shelf of the cells arrangement thus eliminating a need for a vertical movement.

It should be understood that the movements of the actuator lift 54 and article delivery lift 34A is synchronized by the control system 36 to ensure that the actuator 54 and the holder 34A are aligned with the same cell 31. In the specific example of FIGS. 2A-2B, the alignment is such that the actuator 54 and the holder 34A are located exactly opposite each other at, respectively, the rear and front side of the same cell 31.

Thus, when a customer selects an article, the control system 36 operates to determine the specific position of the selected article in the cells arrangement 30 based on the ‘look-up’ table previously created as described above (which is preferably based on the “FIFO” {First In First Out} principle). Then, the control system 36 operates the drive mechanism 40 to provide a relative displacement between the cells arrangement and the article removing assembly 50 (e.g., rotates the cells arrangement 30), and synchrony operates the article delivery assembly 34 and the article removing assembly 50 to bring the holder 34A and the actuator 54 to the alignment with each other and with the selected cell. Alternatively (as indicated above), with fixed cells arrangement 30, the lifts 34A and actuator 54 are rotatable with respect to the cells arrangement. Consequently, with any of the aforesaid alternatives, both actuator 54 and delivering holder 34A are positioned in alignment with a respective cell 31 (e.g., at opposite sides of this cell) in which the selected article is stored. The data reading unit 44A is used here to detect the presence of the selected article in the cell, and if found to identify its exact identification code. If the selected article is not found in the prescribed cell, the control system 36 runs an appropriate algorithm, e.g., based on default steps, such as effecting a search for alternative position where such article is stored according to the ‘look-up’ table (those articles that are not recorded in the “look-up” table inventory will not to be listed/presented to customers). In a case no such alternative cell exists, the control system generates an appropriate message to the customer. If the specific article is identified by the data reading unit, the control system operates the article removing assembly 50 to push the article out of cell to the holder 34A of the article delivery assembly. Once the required article is identified and delivering is commencing (article is pushed through the slot 34B of the holder unit 34A or positioned on the open-design holder, as the case may be), the dispensing port/door (5 in FIG. 1), which is normally closed in order to prevent any unauthorized access to articles, is shifted into its open position, and a customer can access to the article positioned in the article delivery assembly. It should be noted that the door 5 is opened based on predetermined conditions, as described above, namely, after locating the correct article in the delivery assembly and completion of payment process.

A customer may select more than one article to be vended by the machine 1. The prices of the selected articles are added to the customer's shopping card, and the articles might be delivered at a single delivery process. For such option, the article delivery assembly 34 would be appropriately designed (sized). The control system operates to sequentially position the actuator 54 and the holder 34A in alignment with the cells containing the selected articles, thus allowing for collecting, article-by-article, all the selected articles on the holder 34A. Alternatively, the articles may be delivered sequentially. Once a customer completes selection of articles of his interest, the control system 36 creates a delivery scheme. The control system 36, based on appropriate algorithm (e.g., parameters such as fragility, dimensions) determines the order by which the articles will be removed from their cells.

It should be noted that the article delivery assembly may utilize, as alternative of or in addition to the data reading unit, a sensor of the type capable of detecting the existence of an article located therein due to reflected radiation or by other means. Once the presence of the article is detected, the sensor reports the same to the control system 36. The latter, accordingly, stops or prevents any article from being delivered. Such a sensor is therefore used as means to prevent operation problems.

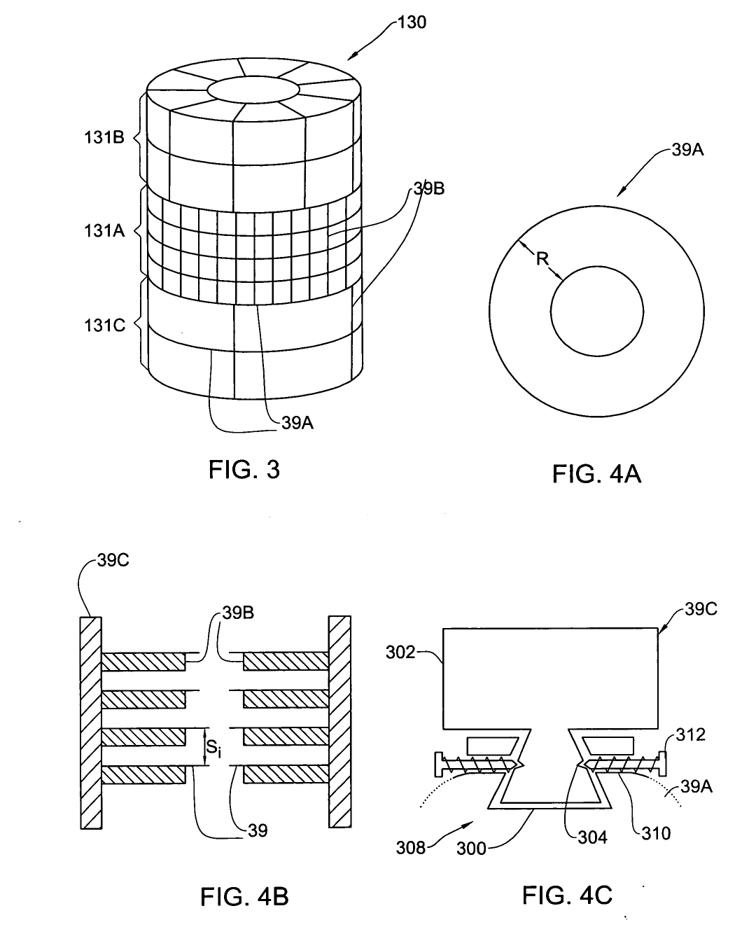

Turning now to FIG. 3, there is shown an example of a cells arrangement 130 suitable to be used in the vending machine of the present invention. The cells arrangement 130 is constructed generally similar to that of FIG. 2A, and distinguishes therefrom in that cells 131 are divided into three different groups of cells having different dimensions, i.e., different widths and/or heights and/or depths: group including the smallest cells 131A, group of cells 131B of a medium size, and group of the largest cells 131C. The cells' configurations are pre-determined by the machine operator(s) based on commercial interests, i.e. according to the types and amounts of articles to be vended (ink cartridges, food, drinks, drugs, DVD's, CD's etc.). The vending machine is therefore not restricted to specific type of articles.

Any required division is accomplished by structuring cells' arrangement out of removable shelves 39A and flexible dividers 39B, which are exemplified in more detail in FIGS. 4A and 4B showing respectively a top and side views of a part of the cells' arrangement. The shelf 39A is a ring-like disc of a certain width R of the ring. Such discs 39A are mounted one above the other. The total number of discs 39A and the internal spacing Sᵢ between any two adjacent discs 39A can be determined by the operator. Evidently, any such combinations of spacings Sᵢ with the total number of discs 39A results in different cell's height. The width of the cells is determined either by (rigid) spacers (e.g., similar to spacing Sᵢ) separated horizontally one from the other according to the desired lateral spacing and mounted on the surface of shelves (not shown) or by removable dividers 39B attached to a rigid stand 39C.

Another embodiment for either non-uniform or uniform spacing between the cells is exemplified in FIG. 4C. The configuration is a superior (from above) view of rigid stand 39C and shelf 39A. Rigid stand 39C has a triangular-like protrusion 300, running parallel to its body 302. From both sides of triangular-like protrusion 300, a triangular-like slot 304 runs parallel to protrusion 300. Shelf 39A has an edge region 308 with a perimeter 310 of an inverted image of protrusion 300 perimeter. Consequently, shelf 39A and protrusion 300 are coupled to each other similar to the key-hole type coupling. The edge portion 308 is formed at both sides thereof with a threaded conveyor, each with a screw 312 therein, where the screw tip presses slot 304. As a result, shelf 39A is fastened to protrusion 300. This mechanism enables the operator of a vending machine to fasten a given shelf to any point along the height of rigid stand 39C, and by that, establishing either uniform or non-uniform spacing. Alternatively, shelf 39A could be fastened to any point along rigid stand 39C using rotatable magnets (not shown) mounted in edge portion 308 where protrusion 300 is a magnetic substance. Thus, rotating the magnets to a position where they are attracted to protrusion 300 fastens shelf 39A to rigid stand 39C, and vice versa.

Other ways for (automatic) structuring and re-sizing cells' arrangement may be used as well.

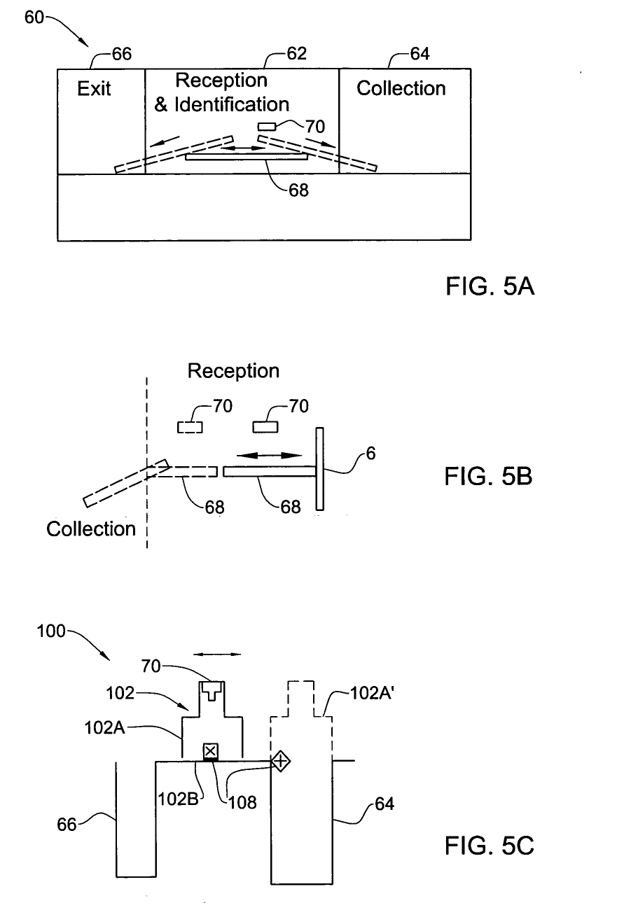

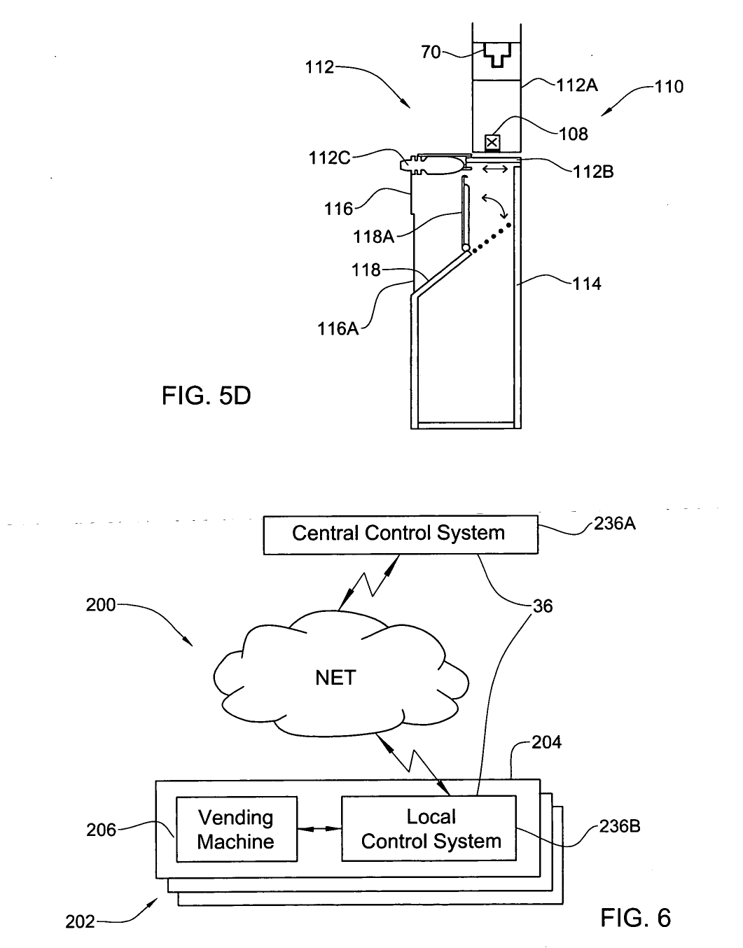

As indicated above, the vending machine preferably includes an article recycling (or return) assembly for collecting articles such as for example ink cartridges to be refilled. At the outer surface of the machine exposed to a customer, the article recycling assembly is constituted by a door (6 in FIG. 1). FIGS. 5A and 5B show two specific, but not limiting examples, of the configuration and operation of the article recycling assembly.

As exemplified in FIG. 5A, the article recycling assembly 60 includes a reception chamber 62 associated with the door (6 in FIG. 1) on the outer surface of the machine housing, a collecting chamber 64, and a non-recyclable (return) exit 66 that may be associated with the same or another door-like opening on the outer surface of the machine housing. The types of articles to be recycled (return) are pre-determined based on various considerations and relevant data is stored in a memory of the control system. Once such data is determined and recorded, the control system operates to allow only certain predetermined articles to be recycled (or return) by the vending machine and reject recycling (or return) of all other articles. The article recycling (or return) assembly 60 operates in the following manner: An article to be recycled (or returned) is inserted by a customer into the reception chamber 62 via the door 6 on the outer surface (see FIG. 1). Being pushed into the chamber 62, the article becomes placed on a loading/unloading member 68. The loading/unloading member 68 has any appropriate design allowing for loading this member with an article and allowing for unloading the article to a predetermined position. In this example, the member 68 is designed like a moveable conveyor, in the form of a support member accommodated between the collection chamber 64 and the recycling (or return) exit chamber 66 and operated by a drive 69 (which is in turn operated by the control system) to be shiftable from its inoperative position (horizontally aligned) into either one of its two operational positions. The shifting is operated by the control system depending on the processing results (i.e., whether the specific article is or is not allowed to be recycled (or return)), such that in its first operational position the member 68 allows loading of the article into the collection chamber 64, and in the second operational position the member 68 unloads the article to the recycling (or return) exit chamber 66. To this end, the article recycling assembly 60 includes an article identifier unit 70 positioned so as to “look” onto the support surface of the loading/unloading member 68. Recycling (or return) instructions for a customer are displayed on screen (3 in FIG. 1). These may include special positioning instructions with respect to the reception chamber 62, placing the article in between a marked area, etc. When the customer initiates the recycling (or return) process, the control system operates the article identifier 70 to identify the article located on the member 68 based on single of combination of predetermined parameters such as dimensions, shape, colors, weight, identification code, etc. The article identifier 70 may include appropriate illuminations means (e.g., LEDs) and detection means (CCD, CMOS color camera or any other suitable detector), and may include a processor for analyzing the detected parameters of the article or alternatively transmit data indicative of the measurements from the detector to the control system whether this data is processed (based for example on pattern recognition).

The article identifier 70 may include a weight, mounted under the location where article to be recycled is positioned by a customer (not shown). Once it is loaded by a customer, the weight of such article is determined. Former to such loading, during a calibration step, such weight is calibrated. Thus, based on the measured weight an article can also be recognized.

If the article is recognized as a recyclable (or allowed to be returned) article, the control system operates the member 68 to load the article into the collection chamber 64, and is the article is recognized as non-recyclable the control unit operates the member to unload the article to the exit chamber 66, and displays relevant data to the customer.

Shifting of the member 68 between its receiving position and one of the article collecting and article existing positions may be implemented by a horizontal movement and in a certain position tilting the member 68 by a certain angle. The article thus slides down into the respective chamber. This is illustrated in FIG. 5B using the same reference numbers to facilitate understanding. As shown, a holder 68 is either initially located so as to allow a customer to place an article thereon, or as shown in dashed lines is movable, upon customer's request, from its inside non-accessible position to that accessible to the customer. An article identifier 70 is located above the holder. Preferably, the configuration is such that a customer has no access to the region inside the machine where the article identification is carrier out. If the article is identified as being recyclable, the holder (operated by the control system) is tilted to allow the article sliding towards the collection channel, and if not the holder moves back in the horizontal plane to output the article.

Collected articles may be kept inside the chamber 66 until an operator discharges them. Alternatively, the machine may operate automatically to detect the existence of the article in the collected chamber and move the article into an empty cell. This may be implemented by the same article delivery assembly and the actuator of the article removing assembly or separate similar assemblies. The article-related data including its position in the cells arrangement is recorded in the “look-up” table, thereby allowing vending of this article again.

FIG. 5C schematically illustrates another example of an article recycling assembly 100. Article recycling assembly 100 includes a reception chamber 102 associated with the door (6 in FIG. 1) on the outer surface of the machine housing, a collecting chamber 64, and a non-recyclable (return) exit 66 that may be associated with the same or another door-like opening on the outer surface of the machine housing. Examples of the types of articles to be recycled (returned) were mentioned above with respect to FIGS. 5A and 5B. Reception chamber 102 is formed by two separated parts, moveable one with respect to the other: a cover 102A located above and separated from a chamber “floor” 102B. In this example, cover 102 is connected to an appropriate driver (not shown) and is thus moveable as shown by arrow in the figure. Consequently, the control unit can operate the movement of cover 102A laterally relative to floor 102B, either towards and above collecting chamber 104 or towards and above non-recyclable (return) exit 106 (a volume from which the non-recyclable (returned) articles are dispensed back from the machine).

The article recycling (or return) assembly 100 operates in the following manner: An article to be recycled (or returned) 108 is inserted by a customer into the reception chamber 102 via the door 6 on the outer surface (see FIG. 1). Being pushed into the chamber 102, the article becomes placed on floor 102B. Article recycling assembly 100 includes an article identifier unit 70 (similar to the one described with respect to FIG. 5A). In addition, or alternatively, depending on the nature of articles to be recycled or returned, if article 108 was identified by article identifier unit 70 as a returnable article, control unit operates cover 102A to move to the right (in FIG. 5C). Such movement brings the left wall of cover 102A to contact with article 108, and consequently pushes it to the right, until the left wall of cover 102A is just above collection chamber 64 (dashed line designated 102A′). At this point, article 108 was pushed already over floor 102B and it is falling directly into collection chamber 64. If article 108 was identified as non-recyclable one, the control unit operates the cover 102 member to unload the article to the exit chamber 66 in a similar mechanism, and displays relevant data to the customer. The rest of the operation and display in this respect were described above with respect to FIGS. 5A and 5B.

According to another preferred embodiment of the invention, article to be returned is inspected by identifier unit 70 in order to check its physical or chemical condition. Physical conditions can be obtained by imaging the article with a CCD. Some chemical properties can be obtained using, e.g., transmission or reflection optics: the article is radiated with light of a suitable wavelength range and the reflected/transmitted light is detected and analyzed, being indicative of the chemical or physical properties of the article. For example, article which are transparent, should transmit the majority of the incoming radiation, whereas if it was covered with dirt, this signal is significantly reduced. Such inspection may reveal defects on the article. Defects can be determined and classified prior to operating the vending machine. Such classifications may refer to conditions according to which the returned article cannot be recycled, or it is useless, or it was damaged by the customer who should compensate for that.

Yet another example of an article recycling assembly 110 is illustrated in FIG. 5D. Article recycling assembly 110 includes a reception chamber 112 associated with the door (6 in FIG. 1) on the outer surface of the machine housing, a collecting chamber 114, and a non-recyclable (return) exit 116 that may be associated with the same or another door-like opening on the outer surface of the machine housing. Reception chamber 112 is formed by a cover 112A located above collecting chamber 114, and horizontally moveable floor 112B. In this example, floor 112B is connected to a driver 112C which upon command from the control unit, can move the floor 112B either to the left (to open reception chamber 112) or to the right (to close it). Non-recyclable (return) exit 116 resides above collecting chamber 114, sharing a common inclined partition wall 118, which has a rotatable part 118A. Thus, reception chamber 112, on which identifier unit 70 (having properties as described above) is also mounted, collecting chamber 114, and non-recyclable (return) exit 116 form a stationary mounted assembly, none of these elements moves with respect to the other. The operation of article recycling assembly 110 is similar to the former embodiment, and specifically, once an article 108 is identified by identifier unit 70 as a returnable article, the control unit (not shown) operates rotatable part 118A to rotate to the left as shown in FIG. 5D (by an actuator, not shown), and operates actuator 112C to move floor 112B to the left, thus reception chamber 112 floor is opened, and article 108 falls down to collecting chamber 114. If article 108 is identified by identifier unit 70 as a non-returnable article, control unit operates rotatable part 118A to rotate to the right (not shown) and operates actuator 112C to move floor 112B to the left, thus reception chamber 112 floor is opened, and article 108 falls down on inclined partition wall 118. Now it is already in the volume of non-recyclable (return) exit 116, it continues and slides due to gravity, down to the exit 116A where it can be picked back by a customer. The mode of floor 112B and rotatable part 118A is controlled by the control unit which synchronizes their operational mode with the operation of article recycling assembly 110.

Loading or unloading of the article is followed by an appropriate message appearing on the screen 3. In a case of recognized recyclable (or return) article, it might also be followed by discharging a receipt or cash to the customer. Generally, the recycling (or return) assembly 60 is managed and controlled by the control system of the machine. When the machine is part of a chain operable via a network (as described below), the recycling (or return) process may be managed by a central control station. The recycling (or return) management includes determination of relevant parameters as type of recyclables, return rate per article, etc.

As indicated above a vending process preferably utilizes a chain of vending machines each connectable to a central control system via a communication network. To this end, a local control system directly connected to the vending machine is installed with suitable hardware/software capable of initiating a client-server session, and suitable application program interface for operating the machine in accordance with commands coming from the central system and for reporting the machine operational status to the central system.

FIG. 6 schematically illustrates a system 200 formed by a chain 202 of remotely located plurality of local stations, generally at 204, each connectable to a central control station 236A via a network, e.g., the Internet. The local station 204 includes a vending machine 206 (for example configured as described above) and a local control system 236B, which is connectable to the network. The control stations 236A and 236B present together the control system 36 operated as described above to manage the vending process of each of the vending machines in the chain. Each machine 206 can be installed in a different place (different places in a building, different places in a town, etc.). The central station 236A manages, operates and controls the network (overall management), where the local control station 236B of each machine 206, with or without human operator, operates and control each machine for itself (local management). Local operation may include the delivery of certain article, whereas overall management determines for example the overall input parameters (articles types, their distribution between the machines, prices, etc.).

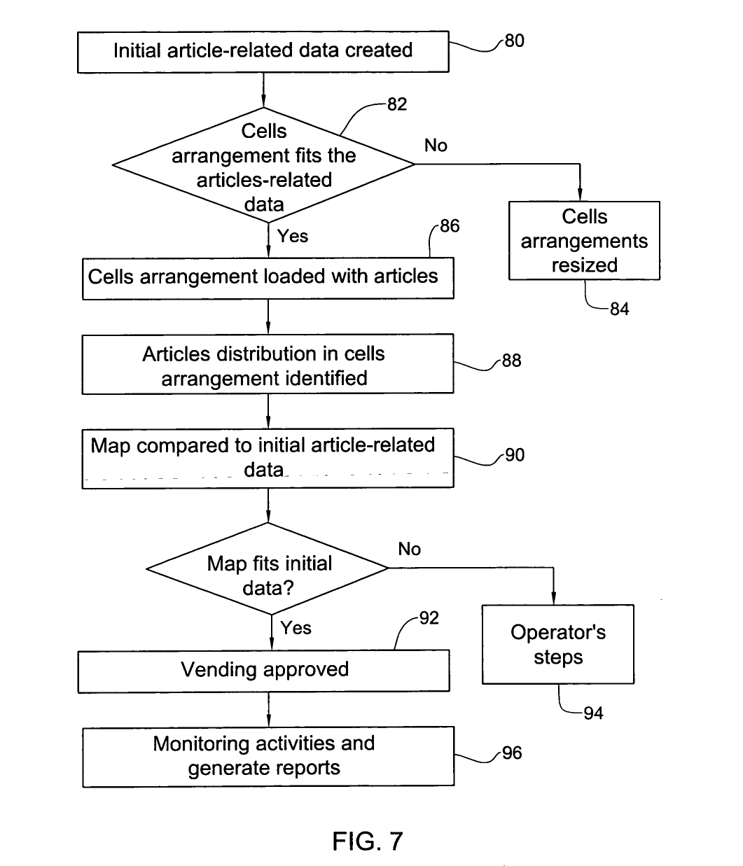

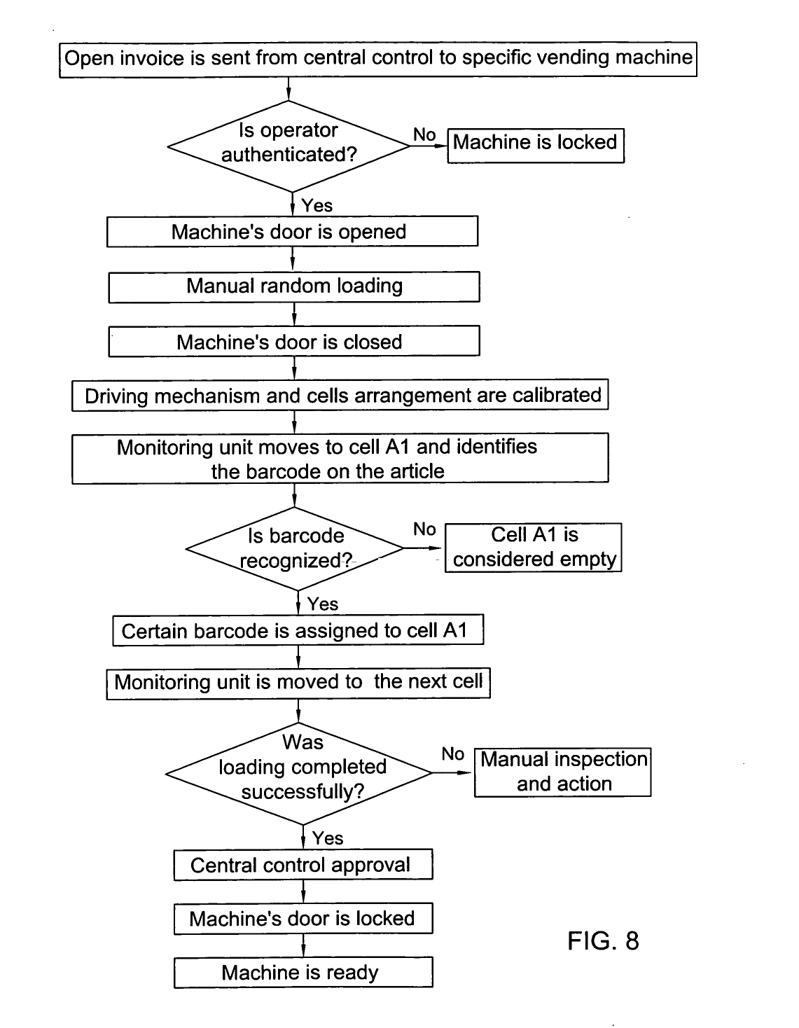

FIG. 7 exemplifies a method for calibrating a vending machine to be ready for vending articles. Referring to a single machine, articles to be vended by this machine are determined and initial article-related data is created (step 80). Based on these data, the mapping assembly automatically determines whether the machine's cells arrangement fits the articles to be loaded (step 82). If not, a machine operator or other automatic means resize the cells arrangement or replaces the cells arrangement by another one (step 84). The articles are loaded in the cells arrangement (step 86), while the loading may be randomly, i.e., any article can be inserted to any cell as far as it fits cell's dimensions. An example of the machine loading procedure will be described below with reference to FIG. 8. It should be noted that the initial article-related data also includes the operation parameters such as prices, types of recyclable articles, discharges, etc.).

After the articles have been loaded, the monitoring system operates to identify the articles distribution within the cells arrangement (step 88). The so-obtained map is automatically compared with the initial article-related data (step 90). If the actual types and amounts of articles fit the initial data, a positive answer is generated and machine is approved for vending (step 92). If not, appropriate steps are taken by machine operator or any involved third party in order to solve the misfit (step 94). The resultant map can be combined with the cells map in order to establish the ‘look-up’ table needed for the delivery process. The machine now starts automatic monitoring the activities over it (dispensing, payment, etc.) and reporting the vending process to the control unit (step 96). If new misfits are found such as discrepancy, at a certain point of time, between the total values of the dispensed articles to the total payment, appropriate steps are taken.

If the vending machine is part of a network, during the creation of the initial data the central station determines the overall distribution articles in the network, e.g., the types, amounts and prices of articles to be stored in each machine of the network, as well as geographical distribution of the machines. Accordingly, articles for loading are provided to human operator together with an invoice. This will enable to monitor articles from the depot center until dispense by customer. For example, the central station will allow operation of the machine, in accordance with the monitoring reports from the local control station. The overall management enables the central station to operate any marketing policy, e.g., distribution of certain articles, in certain amounts to certain machines and for a limited time period (e.g., a “sale”) based on learned experience. Moreover, any report and correlation between any parameter can automatically be prepared for the network or a certain machine.

Preferably, the central or local control station periodically or upon request operates the monitoring system of the machine to update the ‘look-up’ table. This may assist the operator in monitoring the machine and provides for automatically managing the stocks, e.g., whether articles delivery is only due to uptake or maybe thefts. If, as a result of such monitoring, a shortage of an article is determined by the central control in certain machine, it will order the depot center to effect loading of such articles in that machine.

FIG. 8 exemplifies a flow diagram of a method of loading the vending machine with articles. The process starts with an open invoice, prepared and sent by central control system to a specific vending machine. The invoice is printed in order to be handled by an operator who arrives to that machine. As described above, the operator enters his credit card and password into the machine in order to be authorized to access the machine. If the operator's card is authenticated, the door is opened, otherwise, the machine is locked and any access to it is denied. Assuming the machine's door is opened, the operator loads articles into the cell arrangement according to the types and quantities dictated by the open invoice. The specific placement of each article within the machine is arbitrary. Such articles arrived e.g., with a carrier directly from a warehouse or with the operator himself.

Once loading action is completed, the operator closes the door and automatic articles identification starts. First, driving mechanism and cells arrangement are calibrated. Next, the monitoring system (article identifying assembly and/or mapping assembly) can be moved to any point on the cells arrangement. It moves to first cell to be inspected (cell A1), and upon arriving at cell A1, the barcode is identified. If the barcode is not recognized, cell A1 is designated as an empty cell. However, it should be noted that according to another embodiment of the invention, an automatic inspection—verification process could start now, aimed at inspecting and verifying whether barcode is not recognized due to e.g., an empty cell or due to error in barcode reading assembly or driving mechanism.

If the barcode is identified, it is assigned to cell A1. Then the monitoring system is moved by the driving mechanism to the next cell. After certain number of steps in which all the cells were inspected, the identification process is completed. Now the system calculates the following: the number of current stocked articles per type (i.e., prior to loading) plus the number of articles which appear in the invoice per article type, minus the number of identified articles per article type. If the result is zero, then loading was completed successfully, machine door is locked and it is ready for vending process. However, if the result is smaller than zero, it means that there is/are empty cell(s) which does/do not contain article(s), although it/them should have been loaded with. In this case, the operator should analyze the loading report and inspect the cell arrangement according to it until he finds the reason for the missing article(s). Such reason could be for example an error in the stock to be loaded arrived from the warehouse (e.g., missing article) or loading two articles in one cell. Similar inspection process is conducted if the result is positive, i.e. more articles were loaded than appear in the invoice. At either case, once the operator completes his inspection, he asks for central control approval.

If for example, an error was found in the stock arrived from the warehouse, according to lees article than required by invoice arrived, the central control can approve to change the stock and decrease it to the actual loaded amount of articles. When approval is completed, the invoice is closed, the door is locked and the machine is ready for vending.

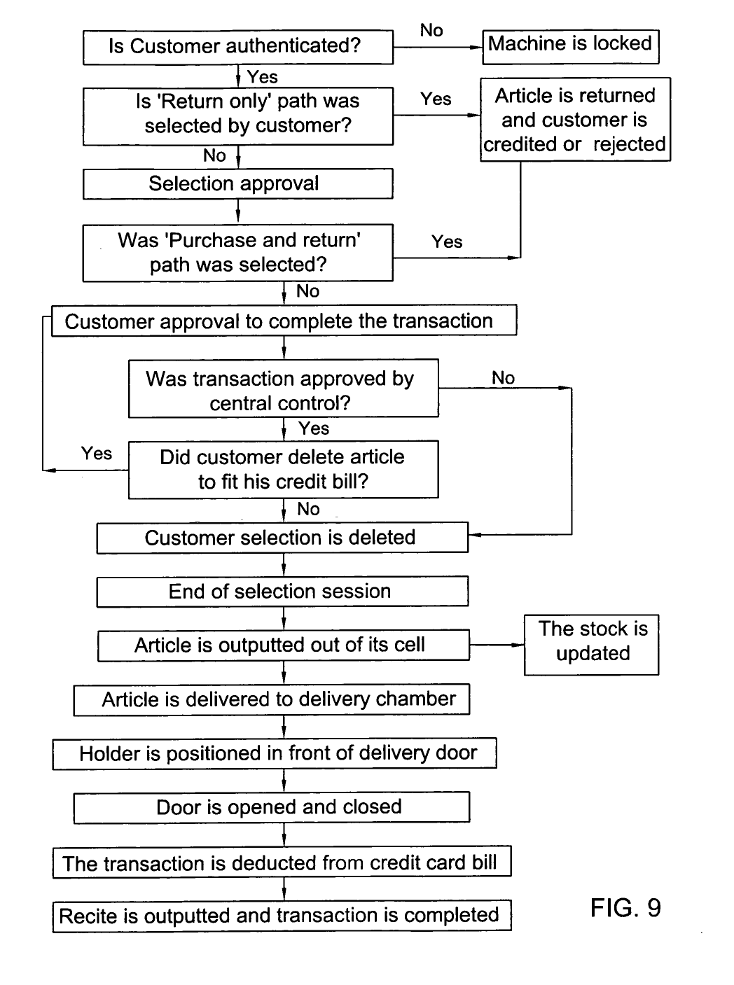

Reference is made to FIG. 9 exemplifying a vending process according to the invention. The process starts with customer authentication. A customer arrives at a specific vending machine either directly, or e.g., after he completed his transaction via the cyberspace. In this example, a direct access is considered. The customer inserts his credit card, and the central control system inspects the card. If it is not authenticated, access is denied. If it is authenticated (e.g., the customer was identified as one that completed a transaction or the credit card is valid), selection screen appears on the machine. Next, the customer chooses for the path he prefers (e.g., return used cartridge (‘return only’), purchase cartridge(s) (‘purchase’), or purchase new cartridge(s) and return used ones (‘purchase and return’). If ‘Return only’ path was selected by the customer, article recycling assembly is operated. The way as to load the retuned article in the reception camber appears on the screen, the customer loads the article and approves loading. Next, the control system operates the article identifier (camera) to locate and image the article. Once the data is processed and the article is identified, it is compared to list of articles allowed to be returned. If it is found valid, the control system actuates the assembly to transfer the article into the collection chamber. The process is completed by an output of recite for the customer as well as crediting his bill or outputting cash money, according to the customer selection. If it was found that the article cannot be returned, the article is outputted and a screen which shows the allowed return options appears to direct the customer. Next, the customer is asked whether he wishes to return more articles, and according to his selection the return process proceeds or completes.

If other path than ‘Return only’ was selected, then, purchase process starts. Products selection screen appears and the customers selects the product(s) he likes, either according to the type of cartridge or according to the printer type. Next, the customer is requested to approve his selection. According to his chose, he can approve, change or delete his selection. At this stage, the customer can add any other available product. Once he approves his choice(s), the central control system proceeds to complete the transaction. If a ‘purchase and return’ path was selected, the control system continues to conduct a ‘return’ path as described above.

Once the customer wishes to complete the transaction, he chooses for transaction approval screen, where he is required to approve his transaction (although he can still continue with purchasing if he likes to). Once the customer approves his transaction, the transaction is inspected by the central control system. Such inspection includes, among other things, verifying if the customer's credit card is valid for the specific transaction. If it is not found valid to complete the specific transaction (e.g., no sufficient credit is assigned to the specific credit card), the customer is informed by the screen on the problem, his directory is deleted and the session is finished. However, the customer has a choice to reduce his purchasing list in order to fit it to his approved credit. If he selects this, the deleted products are deleted form his basket and approval process is conducted again.

Once transaction is approved, the control system proceeds to deliver the article(s). It instructs the driving mechanism to approach the position of first article to be delivered. The articles are chosen according to their loading order, i.e., first loaded first delivered (‘FIFO’). The position is known based on the stocking map which was prepared during the preparation step, and since it was updated after every transaction. Once the article delivery assembly arrived at the appropriate position, it transfers the article out of its cell into the holder. Once this is completed, the control system updates the stock, i.e., deleting the relevant article. According to the articles sizes, few articles could be simultaneously delivered into the holder. If not, the holder is moved to the door where the article is collected by the customer. Once the holder is positioned in front of the door, it is opened for certain time during which the article should be collected. After certain time the door is closed. Once the door is closed, the transaction is deducted from the credit card bill and the transaction is completed.

The vending process preferably provides complementary services to a customer beside vending and recycling (or return), in the same place. This may include provision of more information about the articles vended by machine, as well as related articles which are not directly vended by machine, means to continue the transactions with machine at a different location or means to perform different transaction in a different place which is connected to machine by any business relation (e.g., bill payment via the Internet). All these are termed “information kiosk”. An information kiosk is implemented by an appropriately designed utility formed by specific software loaded in the central control system (236A in FIG. 6) and at least one vending machine. Central control system 236A operates the information kiosk functions by the specific software, and the service itself is given to a customer through the vending machine. More specifically, a customer obtains information about a specific service of the information kiosk by using the machine display (3 in FIG. 1). The service may be completed by payment and deliveries through payment-managing arrangement 4 and dispensing port 5. For example, considering that ink cartridges are vended by the machine, a customer, in addition to recycling such used cartridge back into the machine, can also receive a coupon during the vending process by which he can purchase another article at a special price in a different machine which is member of the specific chain managed via the network. During purchasing or recycling, a customer may receive a coupon to be used later in the nearest retailer or business relation with the machines' chain manager, or the same machine, or at another retailer or another machine located elsewhere, in order to get a discount during purchase of a new ink cartridge. Alternatively, a customer, who has purchased an ink cartridge, may obtain additional information on places where related equipment is sold in discounts, as part of business relation with the machines' chain manager. A coupon is delivered by the information kiosk (equipped with a printer) for such customer in order to get said discount elsewhere. Turning back to FIG. 1, outputs of the aforesaid information kiosk are delivered through a printing port 7 and related information is displayed. To this end, the control system is installed with suitable software for managing the kiosk-related actions and display relevant information to customers, such as payment related data, kiosk operational state (in/out), ticket-related data or any other function of the kiosk arrangement in order to increase customer service rate.

The vending process may utilize a Website in a cyber space. A customer is provided with a Cyberspace Website which is connected to the central control station. In such a Website, a customer can search for an article which is vended by any of vending machines in the chain connectable to the network. A customer may receive data indicative of the geographical locations of the vending machines of the chain and the list of articles available in each of these vending machines. This provides the customer with a convenient pick up. If the customer founds the article of his interest, he can purchase it and determine in which vending machine it will be collected by him. If a purchase order is completed via the Website, the central station instructs the machine, where the article is going to be dispensed, and to keep such article for a pre-determined period of time. It could also allow the customer for prolonged keeping period of the article for additional charge. After the article is dispensed, the local control unit of the relevant machine reports this to the central station, and the stock as well as the reloading lists is updated accordingly. Preferably, the payment is conducted by a credit card. The credit card is not charged, until the article is delivered from the specific machine which the customer designated in the Website and only after the customer has been recognized according to his credit card. In addition, a customer can receive in such Website additional and related information, for example with respect to related articles, or receive purchasing means such as coupons. Therefore, such a Website can also serve as information kiosk.

Those skilled in the art will readily appreciate that various modifications and changes can be applied to the embodiments of the invention as hereinbefore exemplified without departing from its scope defined in and by the appended claims.

1. An automatic vending machine comprising:
(a) a cells' arrangement having an arrays of cells, each for storing at least one article therein,
(b) an article delivering assembly comprising an article holder for receiving at least one predefined article removed from the respective at least one cell and allowing delivery of the at least one removed article to a customer;
(c) a monitoring system comprising an article identifier assembly configured and operable for determining an article-related data in any of the cells thereby enabling arbitrary positioning of the articles within the cells' arrangement; and
(d) a control system connectable to the monitoring system and to the article delivery assembly for selectively operating them and recording data indicative of articles currently stored in the cells' arrangement and of articles removed from the cells' arrangement.

2. The machine of claim 1, wherein the monitoring system comprises a mapping assembly for mapping the cells' arrangement, thereby enabling arbitrary configuring the cells' arrangement and reconfiguring the cells' arrangement when desired.

3. The machine of claim 2, wherein said mapping assembly includes determination of at least one of the following: a pattern of the cells, cells' dimensions, cell's borders, and spatial distribution of the cells within the cells arrangement.

4. The machine of claim 1, comprising a drive mechanism operable to provide a relative displacement between the monitoring system and the cells' arrangement, said drive mechanism being associated with at least a part of the monitoring system and/or the cells' arrangement.

5. The machine of claim 4, wherein the drive mechanism is configured to provide at least one of the following: the relative displacement between the article identifier assembly and the cells' arrangement; and the relative displacement between the cells' arrangement and a mapping assembly of said monitoring system, the mapping assembly being configured for mapping the cells' arrangement thereby enabling reconfiguring of the cells' arrangement when desired.

6. The machine of claim 1, wherein the article identifying assembly is configured for carrying out at least one of the following: reading an identification code provided on the article and generating data indicative thereof, and imaging the cell and generating data indicative of an image of the article contained in said cell or data indicative of that the cell is empty, thereby enabling the identification of the article type according to data stored in the control system.

7. The machine of claim 2, wherein the mapping assembly is configured and operable for imaging each of the cells, thus enabling to identify a type of the article located in the cell.

8. The machine of claim 1, wherein the cells' arrangement has one of the following configurations: a frame with a polygonal outer surface, a frame with a substantially circular outer surface, and a frame with a substantially apiary like outer surface.

9. The machine of claim 1, wherein the cells arrangement is configured to allow for adjusting at least one of dimension and shape of at least some of the cells.

10. The machine of claim 6, wherein said article identifier assembly includes a data reading unit configured for collecting radiation originating from a selected region and generating data indicative thereof.

11. The machine of claim 10, wherein said data reading unit is configured for carrying out one of the following: imaging the selected region, reading an optical barcode, reading a magnetic tag, and reading an RF tag.

12. The machine of claim 1, wherein the control system comprises a local control unit connected to the machine and configured to be connectable to a communication network to enable the machine operation from a remote central station.

13. The machine of claim 6, wherein each of the cells is provided on its inner surface with a marker detectable by the monitoring system when no article is present in the cell.

14. The machine of claim 1, comprising at least one lift unit carrying a data reading unit of said monitoring system and mounted on a guide assembly for movement along at least one axis defined by the guide assembly.

15. The machine of claim 1, wherein the article delivery assembly comprises an article removing assembly.

16. The machine of claim 15, wherein the article removing assembly has one of the following configurations: (i) is mounted on said holder and configured for capturing the article in the cell and transferring it to said holder; and (ii) is adaptive for pushing the article from the cell towards the holder.

17. The machine of claim 16, wherein the article removing assembly comprises an actuator located at a rear side of the cell and operable to push the article in said cell towards the holder.

18. The machine of claim 16, wherein said article removing assembly includes a first lift unit mounted on a guide assembly and driven for a back and forward movement along at least one axis defined by the guide assembly with respect to the cells arrangement.

19. The machine of claim 17, wherein said actuator has one of the following configurations: includes an array of pushing members, each associated with a corresponding one of the cells; and includes a single pushing member, a drive mechanism being provided for relative displacement between said pushing member and the cells arrangement.

20. The machine of claim 19, wherein said article removing assembly includes a first lift unit carrying said holder and mounted on a first guide assembly and driven for a back and forward movement along at least one axis defined by the first guide assembly with respect to the cells arrangement, and a second lift unit carrying the pushing member and mounted on a second guide assembly for the movement along the at least one axis defined by the second guide assembly, the first and second lift units being synchrony operated by the control system so as to match positions of the pushing member and the holder.

21. The machine of claim 1, wherein the article delivery assembly comprises a data reading unit configured for collecting radiation originating from a selected region and generating data indicative thereof, to thereby enable identifying the removed article prior to being delivered to a customer.

22. The machine of claim 21, wherein said data reading unit is part of the monitoring system.

23. The machine of claim 22, wherein said data reading unit is supported on a lift unit mounted on a guide assembly for a back and forward movement along at least one axis defined by the guide assembly with respect to the cells arrangement.

24. The machine of claim 1, comprising an article recycling or returning assembly configured for receiving an article from outside the machine.

25. The machine of claim 24, wherein the recycling or returning assembly comprises an article identifier assembly for identifying the article being input from outside the machine and generating data indicative thereof to the control system, to thereby enable processing of said data and determining whether the article being input is allowed to be collected.

26. The machine of claim 25, comprising an article collection chamber, and an article transfer unit operable by the control system to selectively deliver the recycled or returned article to the collection chamber or dispense the article from the machine.

27. The machine of claim 25, wherein said article identifier assembly of the recycling or returning assembly comprises a data reading unit.

28. The machine of claim 27, wherein said data reading unit is an imaging unit capable of generating the data indicative of the image of the article being input.

29. The machine of claim 27, wherein said data reading unit is configured for determining at least one of the following parameter of the recycled or returned article: identification code on the article, weight, color, size, shape, material composition of the article, and existence of any defect on the article.

30. The machine of claim 25, wherein the recycling or returning assembly comprises a loading/unloading member shiftable from its inoperative position into either one of its two operational positions, the shifting being operated by the control system depending on the processing results, such that in its first operational position the member allows loading of the article being input so as to be collected in the machine, and in the second operational position unloads the article being input towards the outside of the machine.

31. The machine of claim 1, wherein the control system is configured to provide a customer with means for performing transaction for purchasing a selected article via a cyberspace and receiving the purchased article at the vending machine.

32. The machine of claim 31, wherein said means include coupons for purchasing articles.

33. An automatic vending machine comprising:
(a) a cells' arrangement having an arrays of cells, each for storing at least one article therein,
(b) an article delivering assembly comprising an article holder for receiving a predefined article removed from the respective cell and allowing delivery of the removed article to a customer;
(c) a monitoring system configured and operable for determining an article-related data in any of the cells thereby enabling arbitrary positioning of the articles within the cells' arrangement, and for mapping the cells' arrangement, thereby enabling reconfiguring of the cells' arrangement when desired; and
(d) a control system connectable to the monitoring system and to the article delivery assembly for selectively operating these assemblies and recording data indicative of articles currently stored in the cells' arrangement and of article removed from the cells' arrangement.

34. A control system for operating the vending machine of claim 1, the control system comprising:
a memory utility operable for storing data indicative of the cells' arrangement, articles currently stored in the cells' arrangement, and article removed from the cells' arrangement;
a data processing and analyzing utility configured for selectively carrying out the following: managing the memory utility by processing data coming from the monitoring system and indicative of at least one of the articles identified in the machine and/or of the cells' arrangement, and generating data to be stored in the memory and/or to update the previously stored data; managing delivery of the selected article by being responsive to a customer's request and using the stored data to operate an article delivery assembly of the machine and record data indicative of the delivered article.

35. The control system of claim 34, comprising a local control unit and a remote central control station, the local control unit being connectable to the vending machine and connectable to the central control station via a communication network.

36. A method for operating a machine for vending articles, the method comprising:
automatically identifying article-related data with respect to articles currently stored in a cells' arrangement of the machine while being arbitrary distributed in said cells' arrangement and recording data indicative of specific identity or types of the articles and their positions in the machine;
in response to a customer's request, operating delivery of the selected article from the machine to the customer and recording data indicative of delivered articles.

37. The method of claim 36, wherein said automatic identifying comprises mapping the cells' arrangement in the machine intended for storing the articles therein, and recording mapping data indicative thereof.

38. The method of claim 36, wherein said identifying is carried out periodically and/or after the article delivery.

39. The method of claim 36, comprising processing said data indicative of the types of the articles and their positions in the machine to determine whether said data satisfy a predetermined condition.

40. The method of claim 36, comprising identifying an article being input into the machine through a customer-related article recycling or return assembly, to determine whether the article being input is allowed to be recycled or return or not.

41. The method of claim 36, comprising operating the machine by a remote controller connectable to the machine via a communication network.

42. The method of claim 36 comprising upon identifying the selected article, providing a customer with information kiosk including data indicative of at least one of the following: additional information about the selected article or about other articles existing in the vending machine; information allowing the customer to continue transactions with machine at a different location or means to perform different transaction in a different place which is connected to the machine by any business relation.

43. The method of claim 36, comprising providing a customer with purchasing means to be used for purchasing article other than those existing in the vending machine.

44. A method for managing operation of a plurality of the vending machines all relating to a common chain and each configured as the machine of claim 1, said managing comprising: providing each of the vending machines with a local controller and connecting all the local controllers to a central controller via a communication network.

45. The method of claim 44, comprising connecting said central controller to a specific server system of the network to thereby enable customers to have access to a database indicative of distribution of articles in between the plurality of machines and the machines geographical locations.
